(19) United States
(12) Patent Application Publication
(10) Pub. No.: US 2018/0041595 A1
(43) Pub. Date: Feb. 8, 2018

(54) SYSTEM FOR MONITORING RESOURCE ACTIVITY AND ALERT GENERATION

(71) Applicant: BANK OF AMERICA CORPORATION, Charlotte, NC (US)

(72) Inventor: Katherine Dintenfass, Lincoln, RI (US)

(21) Appl. No.: 15/231,345

(22) Filed: Aug. 8, 2016

(51) Int. Cl. H04L 29/08; H04L 12/58

(52) U.S. Cl. CPC H04L 67/22; H04L 51/24; H04L 67/26

(57) ABSTRACT

A resource activity monitoring and alert system comprises a network communication interface and a memory device storing a resource activity monitoring and alert application. A processing device is operatively coupled to the memory device that is configured to execute computer-readable program code to: monitor a user resource activity of a user and determine if a condition applies to the user resource activity; and, upon a determination that the condition applies to the monitored user resource activity, to transmit an alert to the user and a secondary alert to a third party where the third party does not have control over the user resource activity of the user.

### BACKGROUND

Systems for providing on-line and/or mobile transactions are known where a user may engage in a wide variety of different types of transactions with entity systems with which the user has a relationship, such as financial institution systems. The on-line and/or mobile transactions are typically instituted via applications that are accessed from a user device that is in communication with the systems over a network. The user may also engage in a wide variety of face-to-face or physical transactions with the same entity systems. The physical transactions and on-line/mobile transactions may at least partially include the same types of transactions.

### BRIEF SUMMARY

In some embodiments a resource activity monitoring and alert system comprises a network communication interface and a memory device storing a resource activity monitoring and alert application. A processing device is operatively coupled to the memory device, wherein the processing device is configured to execute computer-readable program code to: monitor a user resource activity of a user and determine if a condition applies to the user resource activity; and, upon a determination that the condition applies to the monitored user resource activity, to transmit an alert to the user and a secondary alert to a third party where the third party does not have control over the user resource activity of the user.

The user resource activity may comprise a financial transaction. The resource activity monitoring and alert application may apply logic rules to determine if the condition is met. The logic rules may be predictive. The secondary alert may comprise a secondary alert message sent to a third party device. The secondary alert message may comprise at least one of text, images, and video. The secondary alert message may comprise contact information, the contact information may comprise at least one of a telephone number, e-mail in the form of an active link. The secondary alert message may comprise less information than the alert.

In some embodiments a method for monitoring a resource activity and providing alerts comprises an entity system monitoring a user resource activity of a user related to that entity and determining if a condition applies to the user resource activity; and, upon determining that the condition applies to the monitored user resource activity, transmitting an alert from the entity to the user and a secondary alert to a third party where the third party does not have control over the user resource activity of the user.

Logic rules may be applied to determine if the condition is met. The resource application may comprise an online/mobile banking application and the entity system may comprise a financial institution system. The method may further comprise establishing a first communication channel to a user device and a second communication channel to a third party device. The secondary alert may contain less information than the alert. The secondary alert may comprise a secondary alert message sent to a third party device. The secondary alert message may comprise at least one of text, images, and video and may comprise contact information, the contact information may comprise at least one of a telephone number, e-mail in the form of an active link. The user may grant permission to the entity system to send the secondary alert.

In some embodiments a resource activity monitoring and alert system comprises a network communication interface and a memory device storing a resource activity monitoring and alert application. A processing device is operatively coupled to the memory device and is configured to execute computer-readable program code to: monitor a user resource activity of a user and determine if an alert message is to be to a third party device; and, upon determination that an alert message is to be sent to a third party device, to transmit the alert message to the third party device where the third party device is controlled by a third party that does not have control over the user resource activity of the user. The user resource activity may relate to a financial transaction of a user account. The alert message may comprise at least one of text, images, and video comprising information about the user resource activity.

### BRIEF DESCRIPTION OF THE DRAWINGS

FIG. 1 is a block diagram illustrating a system for monitoring resource activity and alert generation, in accordance with embodiments of the invention.

FIG. 2 is a block diagram illustrating the mobile computing device of FIG. 1, in accordance with embodiments of the invention.

FIG. 3 is a block diagram illustrating the personal computing device of FIG. 1, in accordance with embodiments of the invention.

FIG. 4 is a block diagram illustrating the financial institution system of FIG. 1, in accordance with embodiments of the invention.

FIG. 5 is a flowchart illustrating methods for monitoring resource activity and alert generation, in accordance with embodiments of the invention.

FIG. 6 is a flowchart useful for illustrating a method for activating the monitoring of resource activity and alert generation, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” and “financial entity” include any organization that processes financial transactions including, but not limited to, banks, credit unions, savings and loan associations, investment companies, stock brokerages, asset management firms, insurance companies and the like.

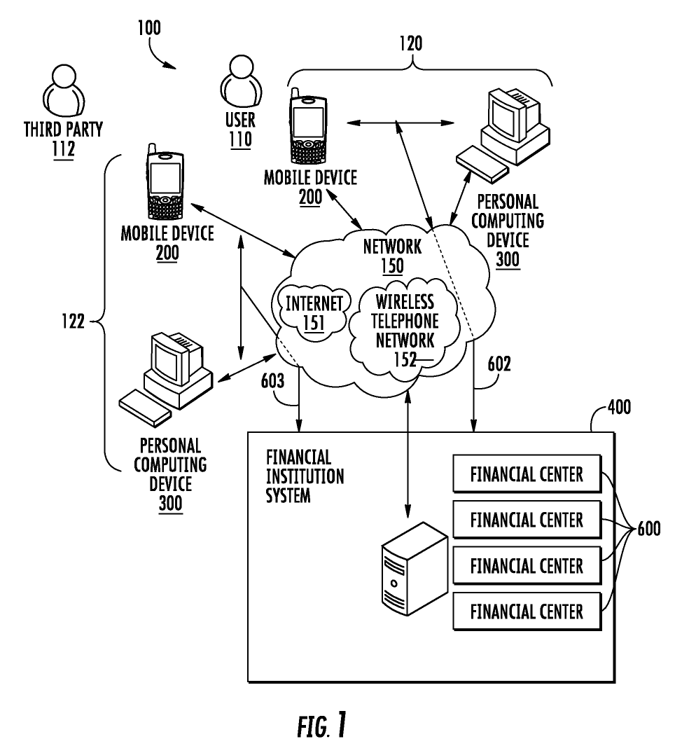

FIG. 1 provides a block diagram illustrating an environment 100 for a system for monitoring resource activity and alert generation, in accordance with an embodiment of the invention. As illustrated in FIG. 1, the environment 100 includes a user 110 where the user represents a customer having a relationship with at least one but typically more than one financial institution. A user of the system may be a person, but may also be a business or any other entity. In a typical environment a great number of users may access the system of the invention. The environment further includes a third party 112 where the third party 112 may comprise any person, business or other entity. The third party 112 may be a customer having a relationship with the financial institution but the third party is not necessarily a customer of the financial institution and may be defined by its relationship with the user 110 as will hereinafter be described.

The environment 100 also may include at least one and in a typical case a plurality of user devices 120 accessible by the user 110 and at least one and in a typical case a plurality of third party devices 122 accessible by the third party 112. The user devices and third party devices may comprise any machine, apparatus, system or the like that may be connected to and communicate over network 150. The term “network device” is used herein to refer collectively to the user devices 110 and third party devices 112. At least one of the network devices may comprise a computing device for use by the user 110 and third party 112. The computing device may be any device that employs a processor and memory and can perform computing functions, such as a personal computing device 300 or a mobile device 200, that may be connected to or access network 150. The network devices 120, 122 may also include a land-line telephone, fax machine or the like. The personal computing devices 300 may comprise a personal computer such as a desk top computer, lap top computer, tablet or any type of personal computing device that may be connected to a network by landline or wireless access such as wireless local area network (WLAN) such as WiFi based on the Institute of Electrical and Electronics Engineers' (IEEE) 802.11 standards, Bluetooth short-wavelength UHF radio waves in the ISM band from 2.4 to 2.485 GHz or other wireless access technology. As used herein, the mobile devices 200 may comprise any mobile communication device, such as a cellular telecommunications device (i.e., a cell phone or mobile phone), personal digital assistant (PDA), a mobile Internet accessing device, or other mobile device. A mobile device may connect to the network by a cellular telecommunications network or by WiFi, Bluetooth or other access technology. In some embodiments where, for example, the user 110 and/or third party 112 is an institution the network devices 120, 122 may comprise servers, access terminals, or the like.

The network devices 120, 122 may be configured to communicate over network 150 with at least one entity system such as financial institution system 400 of an entity such as a financial institution. The network 150 may include a local area network (LAN), a wide area network (WAN), and/or a global area network (GAN). The network 150 may provide for wireline, wireless, or a combination of wireline and wireless communication between devices in the network. In one embodiment, the network 150 includes the Internet 151. In one embodiment, the network 150 may also include a wireless telephone network 152.

In general, the user device 120 is configured to connect with the network 150 and may be used to log the user 110 into the financial institution system 400 of the financial institution. A user 110, in order to access the user's account(s), typically uses an online banking application and/or mobile banking application on the financial institution system 400 and must authenticate with the financial institution system 400. For example, logging into the financial institution system 400 generally requires that the user 110 authenticate his/her/its identity using a user name, a passcode, a cookie, a biometric identifier, a private key, a token, and/or another authentication mechanism that is provided by or for the user 110 to the financial institution system 400 via the user device 120. In some embodiments the authentication system may be a tiered system that may require different levels of authentication based on conditions such as, for example, previous activity of the user over the network 150. For example, the tiered authentication system may have three levels of authentication—hard, medium and soft. Hard authentication may require that the user input a high level of authentication information such as a combination of password, user identification, answer to challenge questions, biometrics, random key number or the like. A hard authentication may be required when the user logs on from an unrecognized user device or where the user activity is not recognized by the system. A medium authentication level may require only a user identification and password. A medium level of authentication may be required where, for example, the user has already logged-in to the user device 120 using an authentication procedure for the device such as a thumbprint or password. A soft authentication may require only a user identification such as user name. A soft level of authentication may be used, for example, where the user has already logged-in to the user device 120 using an authentication procedure for the device such as a thumbprint or password and the user has performed activities on the user device that are recognized as “normal” activity for that user and/or the user device is in a recognized location for that user. Thus, the level of authentication required for accessing the banking application, whether online, mobile or in person, may be adjusted based on conditions, activity, functions or information received about or from the user.

In one embodiment, the invention may provide an application download server such that software applications that support the financial institution system 400 can be downloaded to the user devices 120. In some embodiments of the invention, the application download server is configured to be controlled and managed by one or more third-party data providers (not shown in FIG. 1) over the network 150. In other embodiments, the application download server is configured to be controlled and managed over the network 150 by the same entity or entities that maintains the financial institution system 400

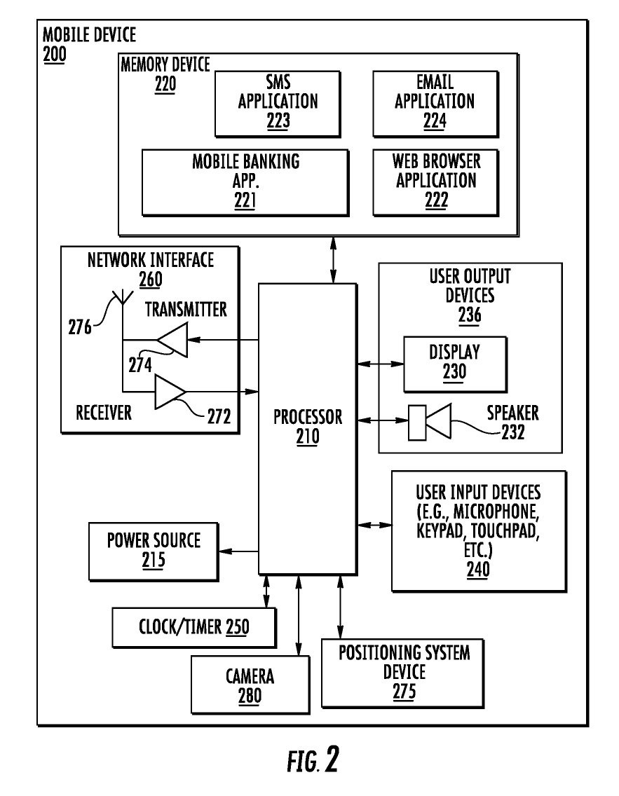

FIG. 2 provides a block diagram illustrating the mobile devices 200 of FIG. 1 in more detail, in accordance with embodiments of the invention. In one embodiment of the invention, the mobile device 200 is a mobile telephone. However, it should be understood that a mobile telephone and the embodiment of the mobile device 200 shown in FIG. 2 are merely illustrative of one type of mobile device 200 that may benefit from, employ, or otherwise be involved with embodiments of the present invention and, therefore, should not be taken to limit the scope of embodiments of the present invention. Other types of mobile devices 200 may include portable digital assistants (PDAs), pagers, tablets, mobile televisions, gaming devices, laptop computers, cameras, video recorders, audio/video player, radio, GPS devices, or any combination of the aforementioned.

Some embodiments of the mobile device 200 include a processor 210 communicably coupled to such devices as a memory device 220, user output devices 236, user input devices 240, and a network interface 260. The mobile device 200 further includes a power source 215, such as a battery, for powering various circuits and other devices that are used to operate the mobile device 200. Embodiments of the mobile device 200 may also include a clock or other timer 250 configured to determine and, in some cases, communicate actual or relative time to the processor 210 or one or more other devices. The mobile device 200 may also include a camera 280 and a positioning system device 275 such as a global positioning system (GPS). The processor 210, and other processing devices described herein, generally include circuitry for implementing communication and/or logic functions of the associated device. For example, the processor 210 may include a digital signal processor device, a microprocessor device, and various analog to digital converters, digital to analog converters, and/or other support circuits. Control and signal processing functions of the mobile device 200 are allocated between these devices according to their respective capabilities. The processor 210 thus may also include the functionality to encode and interleave messages and data prior to modulation and transmission. The processor 210 can additionally include an internal data modem. Further, the processor 210 may include functionality to operate one or more software programs, which may be stored in the memory device 220. For example, the processor 210 may be capable of operating a connectivity program, such as a web browser application 222. The web browser application 222 may then allow the mobile device 200 to transmit and receive web content, such as, for example, location-based content and/or other web page content, according to a Wireless Application Protocol (WAP), Hypertext Transfer Protocol (HTTP), and/or the like. The memory device 220 may include other applications such as e-mail app 224 and SMS app 223.

The processor 210 is configured to use the network interface 260 to communicate with one or more other devices on the network 150. In this regard, the network interface 260 includes an antenna 276 operatively coupled to a transmitter 274 and a receiver 272 (together a “transceiver”). The processor 210 is configured to provide signals to and receive signals from the transmitter 274 and receiver 272, respectively. The signals may include signaling information in accordance with the air interface standard of the applicable cellular system of the wireless telephone network 152. In this regard, the mobile device 200 may be configured to operate with one or more air interface standards, communication protocols, modulation types, and access types. By way of illustration, the mobile device 200 may be configured to operate in accordance with any of a number of first, second, third, and/or fourth-generation communication protocols and/or the like. For example, the mobile device 200 may be configured to operate in accordance with second-generation (2G) wireless communication protocols IS-136 (time division multiple access (TDMA)), GSM (global system for mobile communication), and/or IS-95 (code division multiple access (CDMA)), or with third-generation (3G) wireless communication protocols, such as Consolidated Mobile Telecommunications System (UMTS), CDMA2000, wideband CDMA (WCDMA) and/or time division-synchronous CDMA (TD-SCDMA), with fourth-generation (4G) wireless communication protocols, with LTE protocols, with 3GPP protocols and/or the like. The mobile device 200 may also be configured to operate in accordance with non-cellular communication mechanisms, such as via a wireless local area network (WLAN) or other communication/data networks.

As described above, the mobile device 200 has a user interface that may be made up of user output devices 236 and/or user input devices 240. The user output devices 236 may include a display 230 (e.g., a liquid crystal display or the like) and a speaker 232 or other audio device, which are operatively coupled to the processor 210. The user input devices 240, which allow the mobile device 200 to transmit data, may include any of a number of devices allowing the mobile device 200 to transmit data, such as a keypad, keyboard, touch-screen, touchpad, microphone, mouse, joystick, other pointer device, button, soft key, and/or other input device(s).

The memory device 220 is operatively coupled to the processor 210. The memory device 220 can store any of a number of applications which comprise computer-executable instructions/code executed by the processor 210 to implement the functions of the mobile device 200 and/or one or more of the process/method steps described herein. The memory device 220 also includes a mobile banking application 221 that may be used to allow communication with a system such as the financial institution system 400 to implement the system of the invention. The use of the mobile banking application 221 may facilitate access to the system of the invention by providing log-in systems including user authentication systems, account information, system controls or the like. The mobile banking application 221 also allows communication to the financial institution to allow the user to set up and/or control the system of the invention. The third party 112 is defined by its relationship with the user 110 rather than with the financial institution 400 as will be described. Therefore the mobile device 200 of the third party 112 may not include the mobile banking application 221 because the third party 112 may not have a relationship with the financial institution 400. In some embodiments the third party 112 may have a relationship with the financial institution 400 such that the mobile device of the third party 112 may have a mobile banking application 221. In other embodiments the mobile device of the third party 112 may have a mobile banking application but with a different financial institution.

These applications also typically provide a graphical user interface (GUI) on the display 230 that allows the user 110 to communicate with the mobile device 200, the financial institution system 400 and/or other devices or systems. The memory device 220 can also store any of a number of pieces of information, and data, used by the mobile device 200 and the applications and devices that make up the mobile device 200 or are in communication with the mobile device 200 to implement the functions of the mobile device 200 and/or the other systems described herein. For example, the memory device 220 may include such data as user authentication information.

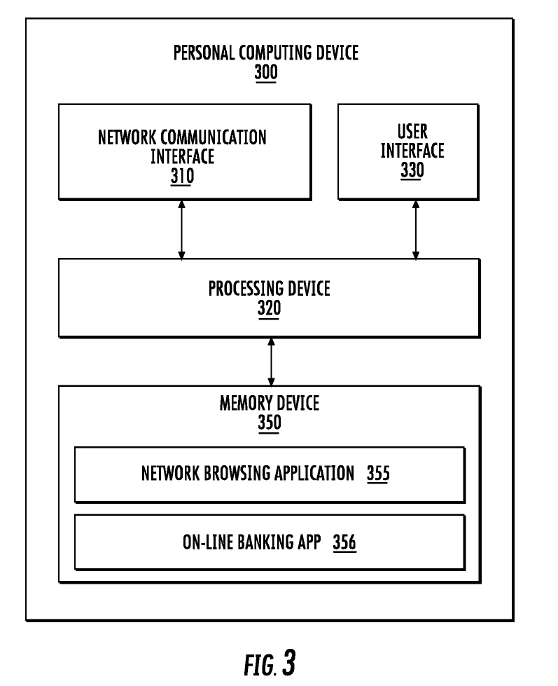

Referring now to FIG. 3, the personal computing device 300 also includes various features, such as a network communication interface 310, a processing device 320, a user interface 330, and a memory device 350. The network communication interface 310 includes a device that allows the personal computing device 300 to communicate over the network 150. In one embodiment of the invention, a network browsing application 355 provides for a user to establish network communication with a financial institution system 400. The memory device 350 may include such applications as the conventional web browser application 355 and/or an on-line banking application 356. The on-line banking application 356 may be used to allow communication with the entity system such as financial institution system 400 to provide access to the financial institution system providing log-in systems including user authentication systems, account information or the like as previously described with respect to FIG. 2. The on-line banking application 356 also allows communication to the financial institution system 400 to allow the user to set up and/or control the system of the invention. Like the mobile device, the personal computing device 300 of the third party 112 may not include the on-line banking application 356 because the third party 112 may not have a relationship with the financial institution 400. In some embodiments the third party 112 may have a relationship with the financial institution 400 such that the personal computing device of the third party 112 may have an on-line mobile banking application 356. In other embodiments the personal computing device of the third party 112 may have a mobile banking application but with a different financial institution. As previously explained, the third party is defined by its relationship with the user 110 rather than with the financial institution 400 as will be described.

As used herein, a “processor” or “processing device,” such as the processing device 320, processing device 420 and processor 210, generally refers to a device or combination of devices having circuitry used for implementing the communication and/or logic functions of a particular system. For example, a processing device or processor may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device or processor may further include functionality to operate one or more software programs based on computer-executable program code thereof, which may be stored in memory device. As the phrase is used herein, a processor or processing device may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” generally includes a plurality of user input and output devices and/or software that allow a customer to input commands and data to direct the processing device to execute instructions and to receive communications from the network devices 120, 122. For example, the user interface 330 presented in FIG. 3 may include a graphical user interface (GUI) or an interface to input computer-executable instructions that direct the processing device 320 to carry out specific functions and an output to communicate with the user 110 and/or third party 112. The user interface 330 employs certain user input and user output devices as previously described with reference to FIGS. 1 and 2. These input and output devices may include a display, mouse, keyboard, button, touchpad, touch screen, microphone, speaker, LED, light, joystick, switch, buzzer, bell, and/or other user input/output device for communicating with one or more users.

As used herein, a “memory” or “memory device” generally refers to a device or combination of devices that store one or more forms of computer-readable media for storing data and/or computer-executable program code/instructions. Computer-readable media is defined in greater detail below. For example, in one embodiment, the memory devices described herein include any computer memory that provides an actual or virtual space to temporarily or permanently store data and/or commands provided to the processing device when the processing device carries out its functions described herein. As used herein, “memory” or “memory device” includes any computer readable medium (as defined herein below) configured to store data, code, or other information. The memory may include volatile memory, such as volatile Random Access Memory (RAM) including a cache area for the temporary storage of data. The memory may also include non-volatile memory, which can be embedded and/or may be removable. The non-volatile memory can additionally or alternatively include an electrically erasable programmable read-only memory (EEPROM), flash memory or the like.

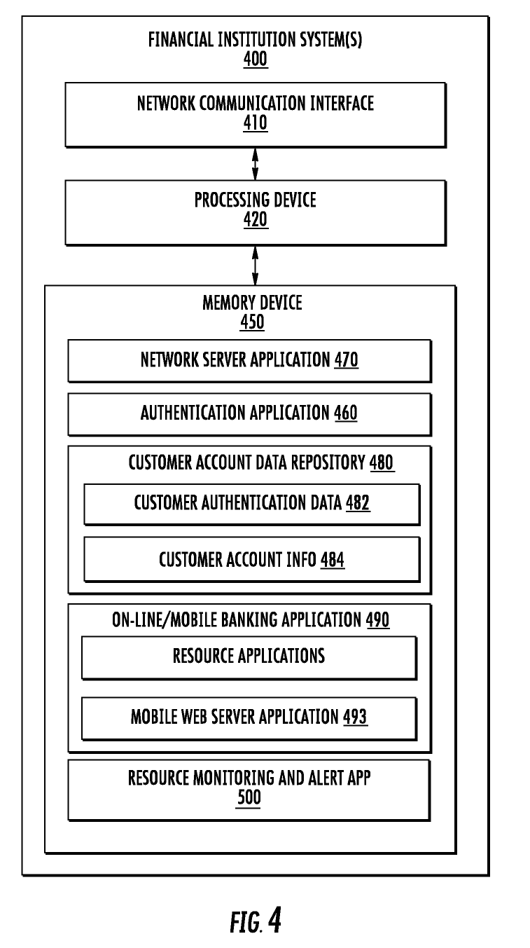

FIG. 4 provides a block diagram illustrating the entity system such as financial institution system 400, in greater detail, in accordance with embodiments of the invention. As illustrated in FIG. 4, in one embodiment of the invention, the financial institution system 400 includes one or more processing devices 420 operatively coupled to one or more network communication interfaces 410 and one or more memory devices 450. In certain embodiments, the financial institution system 400 is operated by an entity, such as a financial institution.

It should be understood that the memory device 450 may include one or more databases or other data structures/repositories. The memory device 450 also includes computer-executable program code that instructs the processing device 420 to operate the network communication interface 410 to perform certain communication functions of the financial institution system 400 described herein. For example, in one embodiment of the financial institution system 400, the memory device 450 includes, but is not limited to, a network server application 470, an authentication application 460, a customer account data repository 480 which includes customer authentication data 482 and customer account information 484, an on-line/mobile banking application 490 comprising a mobile web server application 493, and other computer-executable instructions or other data such as resource applications for executing transactions with the financial institution. The computer-executable program code of the network server application 470, the authentication application 460, or the on-line/mobile banking application 490 may instruct the processing device 420 to perform certain logic, data-processing, and data-storing functions of the financial institution system(s) 400 described herein, as well as communication functions of the financial institution system(s) 400. The mobile banking application 490 communicates with the user computing devices 120 to facilitate communication between the user and the financial institution.

In one embodiment, the customer account data repository 480 includes customer authentication data 482 and customer account information 484. The network server application 470, the authentication application 460, and the mobile banking application 490 are configured to invoke or use the customer account information 484, the customer authentication data 482 when authenticating a user to the financial institution system(s) 400.

The financial institution system 400 further includes a resource activity monitoring and alert application 500 that communicates with the user device 120 and/or the third party device 122 as will be described. The resource activity monitoring and alert application 500 functions to track and monitor the activity related to a user's resources such as the user's financial transaction data with the financial institution including, but not limited to, account information such as balances, payments, withdrawals, deposits, credit/debit card activity, transaction history and other financial activities and transactions, and customer account data. Such resource activities are referred to collectively as “user resource activity.” User resource activity is not necessarily initiated by the user nor is it necessarily initiated from or by a user device 120. Rather a user resource activity means any activity related to the user's resources with an entity system such as a financial institution system 400 that may create a condition that initiates the resource activity monitoring and alert application as described herein. For example, the system may monitor a user's credit card account for suspicious activity that may originate from other than the user or user device, or the system may monitor the account balance of an account of the user to detect an overdraft by the user.

As used herein, a “communication interface” generally includes a modem, server, transceiver, and/or other device for communicating with other devices on a network. The network communication interface 410 is a communication interface having one or more communication devices configured to communicate with one or more other devices on the network 150, such as the mobile device 200, and/or the personal computing device 300. The processing device 420 is configured to use the network communication interface 410 to transmit and/or receive data and/or commands to and/or from the other devices connected to the network 150.

The environment may also comprise at least one financial center 600, FIG. 1, that is related to and may form part of the financial institution that operates and controls the financial institution system 400. The financial center(s) 600 may be a branch office, an ATM machine or other type of facility that may provide in-person customer service and support for the financial institution. The financial centers 600 may also include centralized facilities that are accessible by the distributed financial centers. Typically, the financial institution system 400 comprises a plurality of financial centers that are geographically dispersed to provide services to the financial institution's customers over a wide, and potentially international, geographic area. The financial centers 600 may include at least portions of the financial institution systems 400 that allow each financial center 600 to communicate with other elements of the financial institution system 400 and the user devices 120 over network 150. Each financial center 600 may have access to all or a portion of the financial institution system(s) 400 such that each financial center 600 can communicate with and access at least portions of the processing device 420 and memory device 450 of the financial institution system and in some embodiments the various local systems of the financial centers 600 may be considered to be part of a distributed financial institution system 400. Thus, while the financial centers 600 may be geographically distributed, the financial centers 600 may be considered to form part of the financial institution system(s) 400 as previously described. Each financial center 600 typically includes local processing devices 420 and memory devices 450 and network interface devices 410 that allow the local system of the financial centers 600 to communicate over the network 150 with one another and with centralized systems of the financial institution. The financial centers 600 may also comprise a local customer account data repository, a local online/mobile banking application, a local resource monitoring and alert application facilitate communication, data management and security among the financial centers.

In a typical relationship the user 110 is a customer of the financial institution that operates financial institution system 400 and engages the financial institution for a variety of services and products (e.g. resources). The user may have relationships with more than one financial institution and the relationship between each user and a financial institution may be different where different products and services are provided by the financial institution and/or utilized by the user. In a typical relationship the user 110 may be able to utilize resource applications such as on-line/mobile banking applications 490 of the financial institution that can be accessed through user device 120 to obtain services and products offered by the financial system 400 and to complete financial transactions with and/or through the financial institution. Moreover, at least some of the services and products that are available through the on-line/mobile banking applications 490 are also available as physical transactions. There may also exist some services and products that are available only as physical transactions through a financial center 600. An exemplary suite of resources may include some or all of, but is not limited to, the following: savings/checking accounts, money transfers, mobile/electronic and/or physical check deposit, person-to-person payments (P2P), account statements (checking, savings, term deposits, loans card, equity/fund, insurance and the like), bill payment, cloud storage, ATM withdrawal, financing, portfolio management, stock quotes, location based services, loyalty related agreements, loans, debit/credit cards and the like. The example resources set forth above are not intended to be limiting or exhaustive of the resources that a user may utilize with a financial entity system.

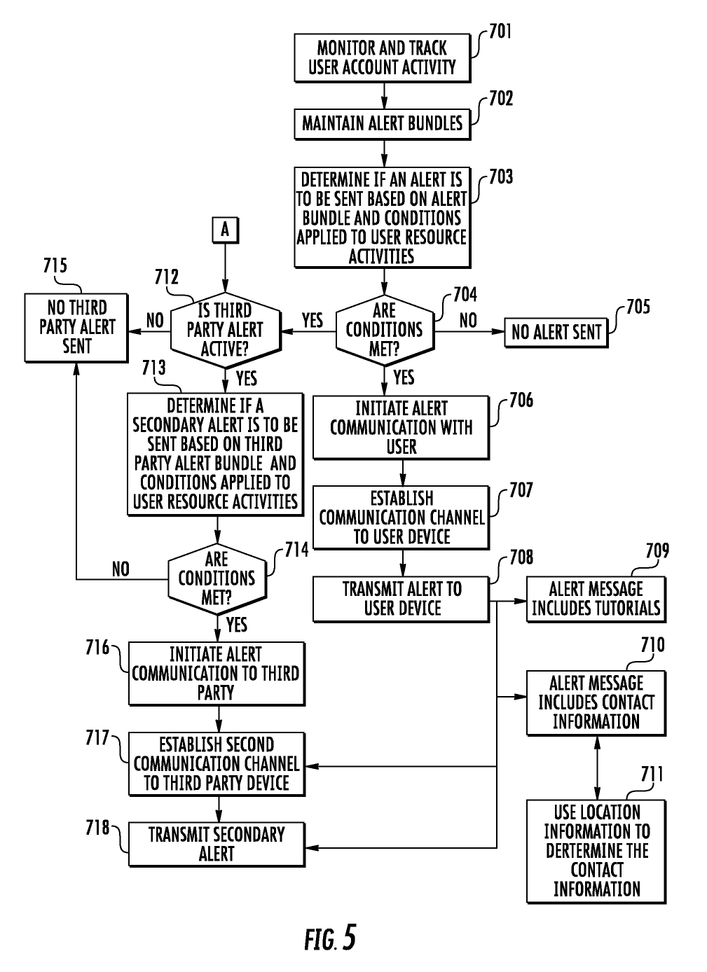

An embodiment of the resource activity monitoring and alert application 500 will be described with reference to FIG. 5. In the illustrated embodiment of the system of the invention, user resource activity is monitored and tracked by the resource activity monitoring and alert application 500 using, at least, data contained in the customer account data repository 480 (Block 701). These data bases maintain records of the resources offered by the financial institution that are utilized by the user as part of the user's relationship with the financial institution and record the user's transactions, transaction history and financial records and other data related to the user. The resource activity monitoring and alert application 500 tracks and monitors the user resource activity for conditions that trigger the sending of an alert to the user device 120. As previously explained, for any user resource activity predetermined conditions may occur that results in the sending of an alert to the user device and/or the third party device.

The resource activity monitoring and alert application 500 also maintains or accesses the user's alert bundle that designates, based on the user's self-selected customized preferences and/or based on rules of the financial institution system 400, particular types, categories or classes of user resource activity and related conditions for which an alert is to be sent to that user (block 702). The alert bundle is the set of user resource activities and related conditions for which an alert is to be sent to the user device 120 for a particular user or for a group of users. The user may request that an alert be sent for one user resource activity and one condition while the rules of the financial institution may require that an alert be sent to the user for a second user resource activity and a second condition. The set of user resource activities and conditions defines the user alert bundle. The resource activity monitoring and alert application 500 determines if any of the conditions of any of the user resource activities require an alert to be sent to the user based on the user's alert bundle (Block 703). In one embodiment, the resource activity monitoring and alert application 500 compares the monitored user resource activity to predetermined conditions for sending alerts. The resource activity monitoring and alert application 500 may apply logic rules to determine if an alert should be sent to the user based on the user resource activity and conditions applied to that activity. The logic rules may be set up by the financial institution and retained in memory device 450 of the financial institution system 400. In some embodiments the resource activity monitoring and alert application 500 may track utilization of all user resource activity. In other embodiments the resource activity monitoring and alert application 500 may only track a subset of the user resource activity based on the user alert bundle and/or other criteria. The system determines if a user resource activity meets the predetermined conditions as set out in the logic rules for an alert (Block 704). If the conditions are not met the system takes no further action and no alert is sent (Block 705). If the conditions are met, the full functionality of the resource activity monitoring and alert application 500 is initiated to transmit an alert message to the user device 120 (Block 706). The user resource activities and the related predetermined conditions for triggering an alert may vary and may be based on any designated user resource activity. For example, the user resource activity may comprise an account balance where the condition is the balance of the account falling below a minimum that may potentially result in an overdraft or penalty. In another exemplary embodiment the user resource activity maybe purchases on a credit or debit card where the related condition is unusual activity on the user account. In another exemplary embodiment the user resource activity maybe purchases on a credit or debit card where the related condition is nearing a credit limit. In another exemplary embodiment the user resource activity may be a direct deposit and the condition may be a missed deposit. In yet another exemplary embodiment the user resource activity may be a loan and the condition may be a late payment. In still another exemplary embodiment the user resource activity may be a loan and the condition may be the dropping the loan balance below a predetermined amount. In yet another exemplary embodiment the user resource activity may be a customer loyalty reward program and the condition may be the accumulation of “points” in the program. These embodiments are made by way of example only and the user resource activity and related conditions may vary from those specifically described herein.

As previously described, in some embodiments logic rules determine the user resource activities and related conditions under which the full functionality of the system of the invention will be initiated to send an alert. In some embodiments the user may at least in part have input in establishing the rules; however, in some embodiments the rules may be established by the financial institution based on data accumulated by the financial institution. For example, the financial institution may track user resource activity for all of the institution's users and transmit an alert message to a particular user device 120 when a predetermined condition occurs for the user resource activity for that user. In some embodiments the full functionality of the resource activity monitoring and alert application 500 is initiated based on the personal preferences established by the individual user where the alert bundle is selected by the user from available alerts offered by the institution. Other rules, conditions and combinations of rules and conditions may be used in addition to those described herein.

In some embodiments, the logic rules may be based on predictive models of user resource activity rather than on actual user resource activity. For example, the system may predict the need for certain financial services or products based on known data about the user when compared to aggregated data from the financial institution system users. For example, the system may predict that a user might be in a potential overdraft situation when the balance in an account falls below a certain level and a regularly occurring future payment is coming due. In other examples the system may be able to predict that the user may require a short term loan based cash flow. Numerous other examples may be provided of the use of a predictive model for initiating the system of the invention and the examples provided above are not intended to be limiting.

If the system of the invention determines, based on the logic rules of the system, that the full functionality of the resource activity monitoring and alert application 500 is to be activated, the resource utilization monitoring and alert application is initiated to communicate with a user device (Block 706). Upon initiation of the resource activity monitoring and alert application 500, at least one communication channel 602 between a user device 120 and the financial institution system 400 may be established (Block 707). The communication channel 602 delivers the alert message to the appropriate user device 120 (Block 708). The alert message may be in the form of text, images, video or a combination of different forms of content. The resource activity monitoring and alert application 500 may transmit an alert message such as a text message, e-mail message or other electronic message to the user device 120. The alert message may provide tutorials dealing with the subject of the alert, help menus, FAQs, or the like (Block 709). In some embodiments the communication channel 602 may be a voice channel between a financial center 600 and a user device 120. The channel may transmit a voice call such as a recorded message, or a message with an option to speak with a live person.

The alert message may also provide contact information to the user (Block 710). The contact information may comprise the telephone number or other contact information for a local financial center 600, directions to the nearest, or a user selected, financial center(s) and/or the telephone number, e-mail address or other contact information for a help desk or the like. The contact information may be provided in the form of an active link that may be selected on the user device to connect the user to the local office or help desk. To select the designated financial center 600 for a particular user the resource activity monitoring and alert application 500 may use the location information provided by the positioning system device 275 on user's mobile device 200 (Block 711). For a personal computing device 300 the contact information may be for the financial center closest to the user's home or work place. In other embodiments the user may manually select a desired financial center.

As described above, the system of the invention provides alerts and other related information directly to the user via a user device 110. In some situations, it may be desirable to provide alerts to a third party in addition to or in place of the alert to the user. The resource activity monitoring and alert application 500 provides a secondary alert where the secondary alert is transmitted to a third party that is not the customer of the financial institution for the user resource activity being monitored. It is contemplated that the secondary alert may be provided to a third party where the third party has a relationship with the user such as a fiduciary, familial, care giver, guardian or other similar relationship but where the third party does not have control over or rights to the accounts, transactions and relationships of the user resource activity being monitored. The user provides alert status to a selected third party or third parties where in some embodiments the user must grant and the third party must accept the third party alert status. While alert status is provided to the third party the third party does not have equal rights or control, or in some embodiments does not have any rights or control, in or over the accounts, transactions and relationships of the user resource activity being monitored. In this manner, while alerts may be provided to the third party, control over the accounts, transactions and relationships of the user resource activity being monitored may be maintained exclusively by the user.

The relationship between the third party and the user and the reasons for providing alert status to a third party may vary depending upon the needs of the user. For example, in some embodiments, the third party may be an adult child or other family member of an elderly user. The elderly user may request that the financial institution system provide the secondary alert to the third party such that the third party may provide some review and/or monitoring of the user's finances without providing control to the third party over the accounts, transactions and relationships of the user with the financial institution. In other embodiments the user may have a disability where third party oversight of alerts is helpful. The third party may be a friend, family member, guardian, institution or the like. In other embodiments the user may be temporarily difficult to reach using the alert system and may require a third party to monitor the user's transactions. For example, the user may be on a military deployment or traveling to remote locations and the third party may be a friend, relative or the like. In other embodiments, the user may be a college student where the user's parents may be given alert status. In other embodiments, the relationship between the user and the third party may be organizational. For example, in a small business the user may be an office manager that has control over the account and the third party may the proprietor that wants to be able to provide oversight over the transactions on the account. In other embodiments the user may be a treasurer of a sports league, community organization, charitable organization or the like and the third parties may be other members of the organization that need to have access to transactions related to the account. The embodiments set forth above are provided by way of example only and are not intended to be limiting or exhaustive. The reasons for providing alert status to a third party and the relationship between the third party and the user may be different than those provided above.

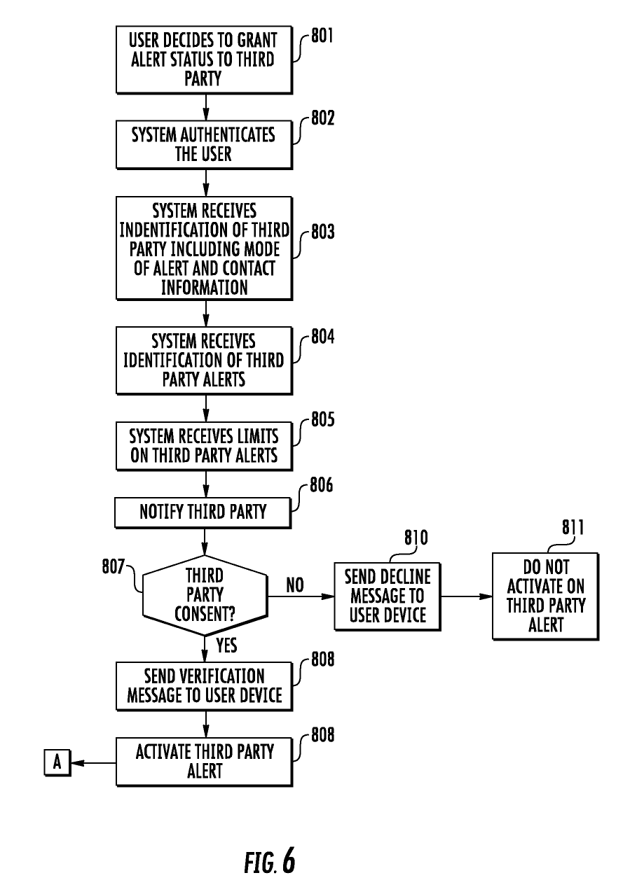

Referring to FIG. 6, as explained above the user opts to grant alert status to a third party. In one embodiment the user may grant alert status to a third party using user device 120 via mobile banking application 221 or on-line banking application 356 (Block 801). The user may also grant alert status via a physical transaction at a financial center 600. The financial system 400 authenticates the user as previously described to establish that the user has the authority to grant alert status to a third party such as via user device 120 (Block 802). The resource activity monitoring and alert application 500 may provide a menu on the user device 120 to guide the user through the process for granting alert status to a selected third party. The resource activity monitoring and alert application 500 receives from the user an identification of the third party including the mode(s) of alert such as text message, facsimile, phone call, e-mail or the like and contact information for the third party such as e-mail address, phone number, fax number or the like (Block 803). The application also may receive from the user an identification of the alerts that are to be provided to the third party (third party alert bundle) (Block 804). The third party alert bundle may be the same as the alert bundle for the user, it may be a subset of the alert bundle for the user or it may be different than the alert bundle for the user. Typically, the alert bundle for the third party is the same as the alert bundle for the user such that the user receives an alert for the user resource activity and condition as the third party. In some embodiments, the third party alert bundle is a subset of the alert bundle for the user such that the third party does not receive alerts for all of the user resource activities and conditions for which the user receives alerts. In other embodiments the third party alerts may be for different user resource activities and conditions that the user alerts. The user may define the alerts by transaction type, class of transaction, account, type of account or the like.

The grant of alert status may be limited by time, specific account, account type, transaction type or other parameter (Block 805). In one embodiment, the third party may be notified of the third party alert arrangement as set up by the user (Block 806). The third party may accept or decline the alert arrangement (Block 807). If the third party accepts the alert arrangement, a verification message may be sent to the user confirming that the third party alert system is active (Block 808). The third party alert is then activated (Block 809). If the third party does not accept the alert arrangement a decline message may be sent to the user informing the user that the third party has declined the arrangement (Block 810). The third party alert system is not active (Block 811).

For the third party alert bundle granted to the third party the system monitors the user's accounts, transaction history and relationship with the institution as previously described. When a predetermined condition is met for a monitored user resource activity and that user resource activity and condition are part of the third party alert bundle, a secondary alert may be sent to the third party in addition to the alert sent to the user. Because the third party does not have control over the user accounts and does not typically have rights to authorize activity on the user accounts, the secondary alert provided to the third party is primarily informational. The third party must typically contact the user in order for any action to be taken in response to the alert. In some embodiments the secondary alert provided to the third party may include less or different information than the alert provided to the user. For example, an alert for an overdraft of a checking account provided to the user may include the payee of the check, check number, amount or the like. The secondary alert provided to the third party may include only an identification of the account without any additional details. In this manner the user may control the amount of information provided to the third party and the secondary alert may be used only for notification without providing detailed information. The user may set the amount and types of information provided to the third party when setting up the third party alert.

Once the third party alert is activated (Block 712) the resource activity monitoring and alert application 500 the resource activity monitoring and alert application 500 determines if any of the conditions of any of the user resource activities require a secondary alert to be sent to the third party based on the user's third party alert bundle (Block 713). In one embodiment, the resource activity monitoring and alert application 500 compares the monitored user resource activity to predetermined conditions for sending secondary alerts. The resource activity monitoring and alert application 500 may apply logic rules to determine if a secondary alert should be sent to the third party device based on the user resource activity and conditions applied to that activity. The logic rules may be set up by the financial institution and retained in memory device 450 of the financial institution system 400 as previously explained. The system determines if a user resource activity meets the predetermined conditions as set out in the logic rules for a secondary alert (Block 714). If the conditions are not met the system takes no further action and no secondary alert is sent (Block 715). If the system of the invention determines, based on the logic rules of the system, that the full functionality of the resource activity monitoring and alert application 500 is to be activated, the resource utilization monitoring and alert application is initiated to communicate with a third party device (Block 716). At least one second communication channel 603 between a third party device 122 and the financial institution system 400 may be established (Block 717). The communication channel 602 delivers the secondary alert message to the appropriate third party device 122 (Block 718). The secondary alert message may be in the form of text, images, video or a combination of different forms of content. The resource activity monitoring and alert application 500 may transmit a secondary alert message such as a text message, e-mail message or other electronic message to the third party device 122. The secondary alert message may provide tutorials dealing with the subject of the alert, help menus, FAQs, or the like (Block 709). In some embodiments the communication channel 603 may be a voice channel between a financial center 600 and a third party device 122. The channel may transmit a voice call such as a recorded message, or a message with an option to speak with a live person.

The alert message may also provide contact information to the third party device (Block 710). The contact information may comprise the telephone number or other contact information for a local financial center 600, directions to the nearest, or a user selected, financial center(s) and/or the telephone number, e-mail address or other contact information for a help desk or the like. The contact information may be provided in the form of an active link that may be selected on the third party device to connect the third party to the local office or help desk. To select the designated financial center 600 for a particular third party the resource activity monitoring and alert application 500 may use the location information provided by the positioning system device 275 on third party's mobile device 200 (Block 711). For a personal computing device 300 the contact information may be for the financial center closest to the third party's home or work place. In other embodiments the third party may manually select a desired financial center.

When a monitored user resource activity and related condition is identified indicating that an alert is to be sent to the user and/or third party, the system determines the type of alert to be sent to each entity. As previously explained the user alert may be sent to a first location such as a user device 120. The third party alert is sent to the third party based on the contact information provided by the user when setting up the third party alert system. The third party alert may be sent to a third party device 122. The system also determines the content and format of the alert message. The user alert may include additional information not provided in the third party alert. Moreover, the user alert may include functionality not provided in the third party alert. For example the user alert may include a link that may be used to connect the user to a financial center, to the user's on-line/mobile banking application or the like. Because the third party does not have rights and control of the user accounts, the third party alert may not include links to the financial system. In some embodiments, a link may be provided in the third party alert that may be used to connect the third party to the user as directed by the user during set up of the third party alert system. For example, the third party alert may be a text message to a third party mobile device, where the message includes a live link to the user's phone number or e-mail address. In this manner while the third party cannot access or control the user accounts, the third party may be conveniently connected to the user.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium. Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s).

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

### INCORPORATION BY REFERENCE

To supplement the present disclosure, this application further incorporates entirely by reference the following commonly assigned patent applications:

| | U.S. Patent Application | | |
|---|---|---|---|
| Docket Number | Ser. No. | Title | Filed On |
| 7259US1.014033.2850 | To be assigned | RESOURCE TRACKING | Concurrently |
| | | AND UTILIZATION | herewith |
| | | SYSTEM | |
| 7261US1.014033.2851 | To be assigned | RESOURCE ASSIGNMENT | Concurrently |
| | | SYSTEM | herewith |
| 7262US1.014033.2852 | To be assigned | RESOURCE ASSIGNMENT | Concurrently |
| | | SYSTEM WITH | herewith |
| | | ALLOCATION ASSIST | |
| 7263US1.014033.2853 | To be assigned | SYSTEM FOR RESOURCE | Concurrently |
| | | ALLOCATION AT TIME OF | herewith |
| | | USE AND CONSERVATION | |
| | | OF UNUSED PORTION | |
| 7264US1.014033.2854 | To be assigned | SYSTEM FOR RESOURCE | Concurrently |
| | | ALLOCATION AND | herewith |
| | | CONSERVATION OF | |
| | | UNUSED PORTION | |

1. A resource activity monitoring and alert system comprising:
a network communication interface;
a memory device storing a resource activity monitoring and alert application;
a processing device operatively coupled to the memory device, wherein the processing device is configured to execute computer-readable program code to:
monitor a user resource activity of a user and determine if a condition applies to the user resource activity;
upon determination that the condition applies to the monitored user resource activity, to transmit an alert to the user and a secondary alert to a third party where the third party does not have control over the user resource activity of the user.

2. The system of claim 1 wherein the user resource activity comprises a financial transaction.

3. The system of claim 1 wherein the resource activity monitoring and alert application applies logic rules to determine if the condition is met.

4. The system of claim 1 wherein the logic rules are predictive.

5. The system of claim 1 wherein the secondary alert comprises a secondary alert message sent to a third party device.

6. The system of claim 5 wherein the secondary alert message comprises at least one of text, images, and video.

7. The system of claim 5 wherein the secondary alert message comprises contact information, the contact information comprising at least one of a telephone number, e-mail in the form of an active link.

8. The system of claim 5 wherein the secondary alert message comprises less information than the alert.

9. A method for monitoring a resource activity and providing alerts, the method comprising:
an entity system monitoring a user resource activity of a user related to that entity and determining if a condition applies to the user resource activity;
upon determining that the condition applies to the monitored user resource activity, transmitting an alert from the entity to the user and a secondary alert to a third party where the third party does not have control over the user resource activity of the user.

10. The method of claim 9 applying logic rules to determine if the condition is met.

11. The method of claim 9 wherein the resource application comprises an online/mobile banking application and the entity system comprises a financial institution system.

12. The method of claim 9 further establishing a first communication channel to a user device and a second communication channel to a third party device.

13. The method of claim 9 wherein the secondary alert contains less information than the alert.

14. The method of claim 9 wherein the secondary alert comprises a secondary alert message sent to a third party device.

15. The method of claim 14 wherein the secondary alert message comprises at least one of text, images, and video.

16. The system of claim 14 wherein the secondary alert message comprises contact information, the contact information comprising at least one of a telephone number, e-mail in the form of an active link.

17. The method of claim 9 wherein the user grants permission to the entity system to send the secondary alert.

18. A resource activity monitoring and alert system comprising:
a network communication interface;
a memory device storing a resource activity monitoring and alert application;
a processing device operatively coupled to the memory device, wherein the processing device is configured to execute computer-readable program code to:
monitor a user resource activity of a user and determine if an alert message is to be to a third party device;
upon determination that an alert message is to be sent to a third party device, to transmit the alert message to the third party device where the third party device is controlled by a third party that does not have control over the user resource activity of the user.

19. The system of claim 18 wherein the user resource activity relates to a financial transaction of a user account.

20. The system of claim 18 the alert message comprises at least one of text, images, and video comprising information about the user resource activity.
